(19) United States
(12) Patent Application Publication
(10) Pub. No.: US 2010/0283404 A1
(43) Pub. Date: Nov. 11, 2010

(54) Illumination Device with Solid State "Array" Emitters

(76) Inventor: Glenn R. Thoren, SR., Chelmsford, MA (US)

Correspondence Address: L-3 INSIGHT TECHNOLOGY INCORPORATED;ATTN: PETER W. MURPHY, 9 AKIRA WAY, LONDONDERRY, NH, 03053, US

(21) Appl. No.: 12/144,053

(22) Filed: Jun. 23, 2008

Related U.S. Application Data
(60) Provisional application No. 60/945,389, filed on Jun. 21, 2007.

(51) Int. Cl. H05B 37/02; F21L 4/02

(52) U.S. Cl. 315/294; 362/184

(57) ABSTRACT

An illumination device utilizes one or more laser array emitters to provide a compact, high power light source useful for illuminating objects or areas of interest and in searching for items that may fluores when illuminated by light that interacts with material in or on the items. The illumination device is capable of providing a retina safe output at an object based on the distance from the illuminator to the object.

### CROSS-REFERENCE TO RELATED APPLICATIONS

This application claims the benefit of U.S. provisional patent application Ser. No. 60/945,389 filed Jun. 21, 2007. The entire disclosure of which is incorporated herein by reference in its entirety.

### BACKGROUND OF THE INVENTION

FIG. 1 discloses an illumination device that requires multiple individually aligned lasers or LEDs. Reflections or secondary emissions bouncing off of an object or area of interest may be seen with night vision equipment, infrared or other imagers, or the naked eye.

Current implementations of illumination devices also require that each individual diode be separately mounted and aligned to illuminate the target at a distance with parallel beams. It has not been possible to combine the power of many diodes in the same mechanical and optical structure without great difficulty in mounting and aiming the devices, which are currently separately contained in individual packages.

It has been possible for some time to manufacture many laser diodes on a single wafer as vertical cavity emitting devices (VCSELS) and separate them for use as individual lasers. It has also been possible to capture the energy of an array of devices in a carefully constructed and connectorized array of fiber optic lines to transmit the laser signal emitted from the individual diodes for the purpose of high density interconnects between servers and routers.

### BRIEF DESCRIPTION OF THE DRAWINGS

FIG. 1 is a photograph of an illumination device that employs multiple individual laser diodes.

FIGS. 2A and 2B are photographs of multi-element single-color laser array emitter devices consistent with an embodiment of the invention.

FIG. 3 is a photograph of an illumination device consistent with an embodiment of the invention.

FIG. 4 is a block diagram of a first illumination device consistent with an embodiment of the invention.

FIG. 5 is a photograph of a multi-element multi-color laser array emitter device consistent with an embodiment of the invention.

FIG. 6 is a block diagram of a second illumination device consistent with an embodiment of the invention.

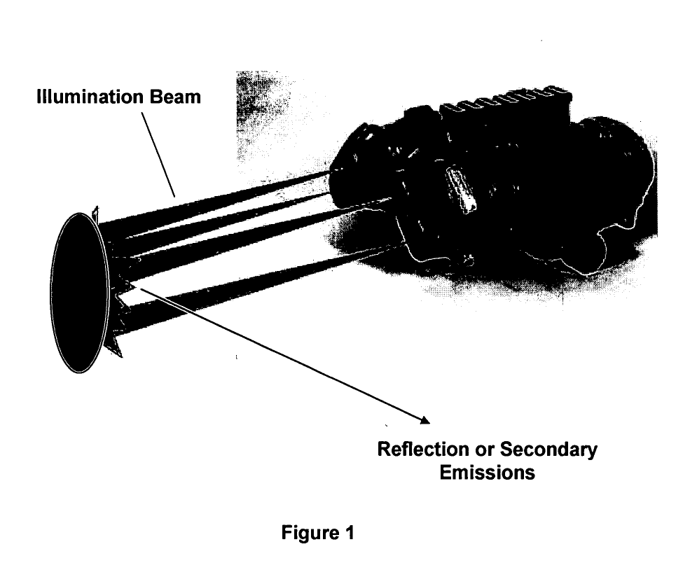

### DETAILED DESCRIPTION

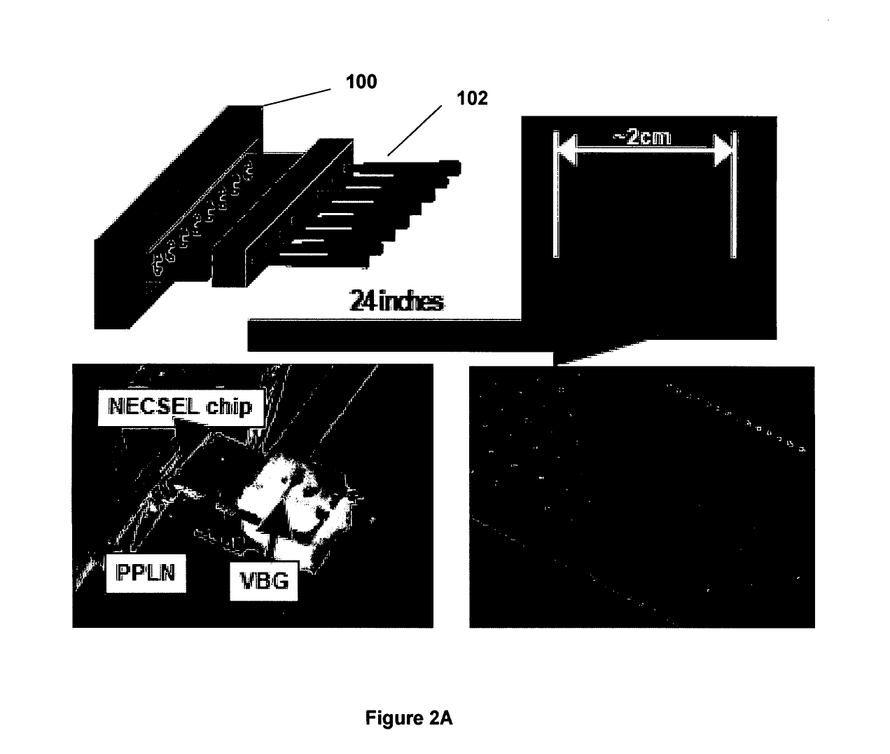

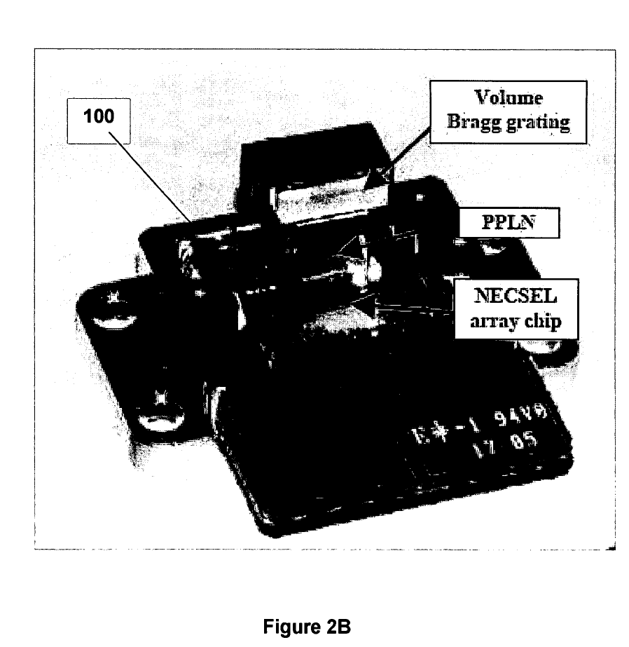

In one embodiment, the illumination device uses one or more arrays of vertical or edge emitting laser diodes or light emitting diodes (LEDs) to provide a high power beam in order to illuminate an object or area of interest or interrogate the environment and reveal through fluorescence, reflection, or other emissions, the presence of materials that may be of interest. FIG. 2A and 2B show a multi-element single-color laser array emitter device 100 with an output beam 102 that may be used in an illumination device consistent with one embodiment of the invention. The wavelength of the output beam 102 may be determined by a selected non-linear crystal.

In one embodiment, the laser arrays could be similar in format to the “NECSEL” arrays available from Novalux Inc., which have been designed for use in projection devices, rear projection television sets, cell phone, and PDA projectors. The vertical cavity (VCSEL) array format is desirable because the devices are created on a single wafer and are capable of transmitting vertically perpendicular to the wafer surface and replace the need for one or more individually packaged laser diodes that must be mechanically mounted and optically aligned to form beams traveling in the same direction. One or more array devices disposed side by side on the same wafer and transmitting in the same direction offer increased power per unit area (or volume) by a factor of 10 to 30 times (depending on the number of emitters) when compared to individually packaged and separately mounted laser diodes. The array devices can significantly lower cost by reducing the time-consuming effort of alignment. Additional mechanical parts that may be susceptible to production variability and potential misalignment due to shock, temperature, and vibration can be eliminated. Wafer fabrication processes and photographic lithography processes help ensure that each vertically emitting laser structure is aligned with a high degree of accuracy to point and project their parallel beams in the same direction.

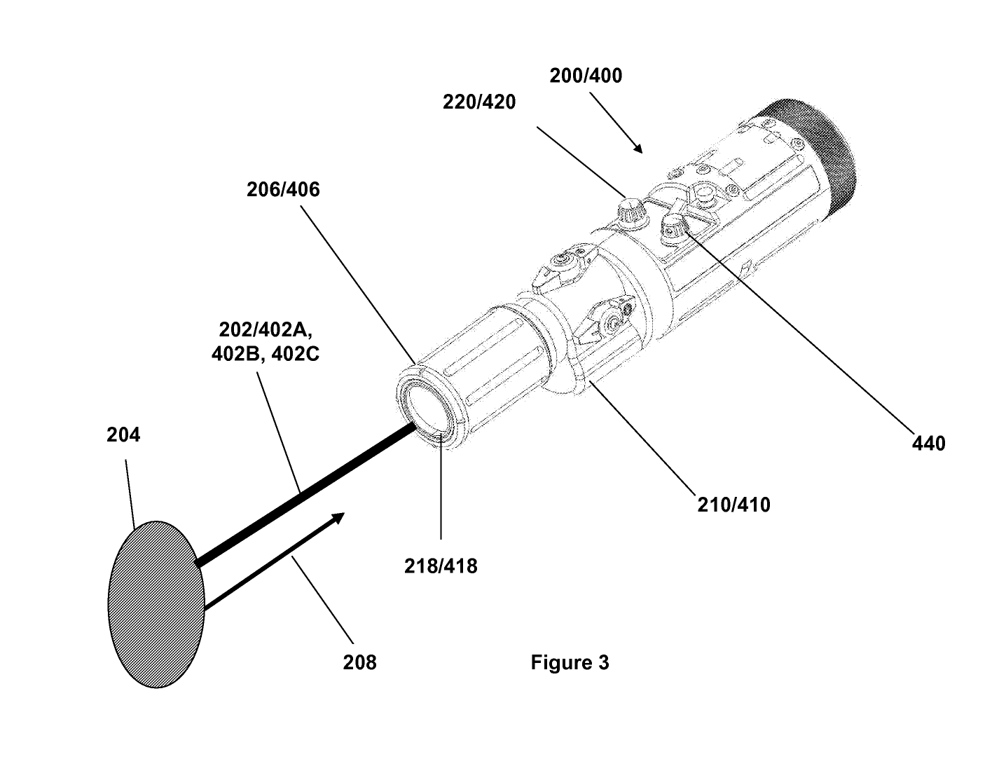

FIG. 3 is a photograph of an illumination device 200/400 utilizing a solid state array emitter device consistent with an embodiment of the invention. The illumination device 200/400 may generate a multi-beam output 202/402A, 402B, 402C used for marking, illuminating, or interrogating an object 204. An adjustor knob 206/406 may be utilized to adjust the divergence of the output 202/402A, 402B, 402C from a pointer (generally non diverging beam) to an illuminator (generally diverging beam). Reflections and secondary emissions 208 bouncing off of the object 204 or area of interest may be seen with night vision equipment, infrared or other imagers, or the naked eye. These reflections or secondary emissions 208 may be used to interrogate the object 204, for example, certain wavelengths of light may be used to cause a target to have energetic emission of photons through fluorescence and luminous excitation which can be interpreted by an operator or an imager. Additionally, the illumination device may be used for gas and biological detection.

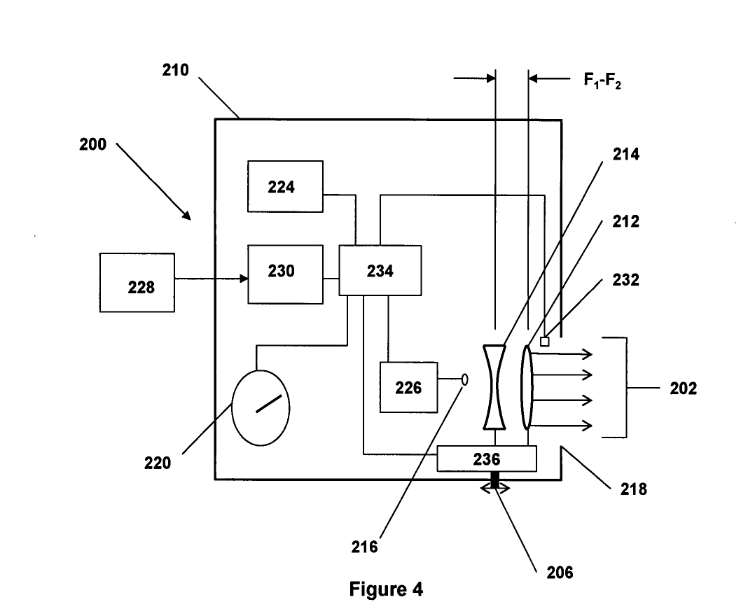

FIG. 4 is a block diagram of the first illumination device 200 consistent with an embodiment of the invention. An afocal beam expander having a first lens 212 with a −F1 focal length and a second lens 214 having a F2 focal length may be disposed a spaced distance F2−F1 from the laser array emitter 216 to provide a collimated light output that extends through an aperture 218. The illumination device 200 may be housed in a housing 210 that can be hand held, weapon-mounted, or mounted on a remotely controllable actuator. A user adjustable adjustor knob 206 may be coupled to the housing 210 and allow an operator to change the distance between the lenses 212, 214 to adjust the divergence of the light output 202 from the device 200 from narrow to wide. The device 200 may have an internal power supply 224, for example a dry cell battery, or may receive power from a remote source. A selector 220 may allow a user to adjust the output power through a controller 234 and a variable laser driver circuit 226.

The illumination device 200 may also be used to project a beam for optical disruption. An optical disruption may be any interruption of the ability of the viewer to see clearly and/or discriminate objects or scenes in such a way that the viewer's perception is disrupted sufficiently to prevent efficient and effective cognitive action based on visual information. If the device 200 is to be used for optical disruption in such a way that it was intended to be “retina safe” it could be coupled to the output of a rangefinder 228 or other target range estimator. A retina safe level is often expressed as a maximum permissible exposure (MPE). MPE is the level of laser radiation to which a person may be exposed without hazardous effects or biological changes in the eye. MPE levels are determined as a function of laser wavelength, exposure time and pulse repetition (see ANSI Z136.1 Standard for the safe use of lasers). The MPE is usually expressed either in terms of radiant exposure in J/cm² or as irradiance in W/cm² for a given wavelength and exposure duration.

The illumination device 200 may be wire or wirelessly coupled to the range finder 228 to determine the distance to the object 204. The distance to target may be inputted into a look-up table 230 and then to the controller 234 and the variable laser driver circuit 226 to keep the power level at the object at or below the retina safe level. The detection of target range by the rangefinder 228 could control the amplitude of the output beam via a photo sensor 232 with the controller 234 to provide light output feedback to control the variable laser driver circuit 226. The device 200 may be calibrated at the time of manufacture and the output beam 202 could be adjusted up or down in power to illuminate objects depending on the range so as not to exceed the retina safe limit.

Alternatively, the output beam 202 could be controlled without active feedback by adjusting the output power based on the distance to target and calibrated output power levels stored in the look-up table 230.

The output beam 202 could also be modified by changes in the optics in front of the beam such that the divergence of the beam would make it retina safe at the distance measured by the rangefinder. An electrically controllable actuator 236 coupled to the controller 234 may control the distance between the first lens 212 and the second lens 214 to adjust the divergence. A combination of controlling the output power and changing the divergence may also be accomplished.

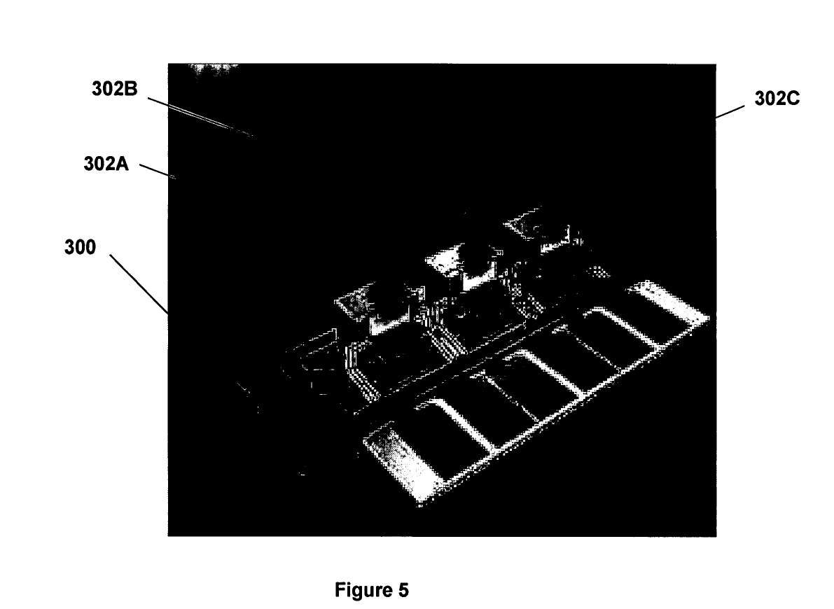

FIG. 5 is a photograph of a multi-element multi-color laser array emitter device 300 consistent with an embodiment of the invention. The device 300 may have a plurality of array emitters capable of generating a plurality of outputs 302A, 302B, 302C having differing wavelengths. The compact design of these array emitters allows them to be located in very close proximity with other wavelengths and thereby save overall system volume. It is possible to share driver electronics and cooling (heating) electronics and mechanical implementations. Multiple wavelengths can be co-located to achieve a smaller and more capable product while conserving overall power, volume, weight, heatsinking, or heater power consumption.

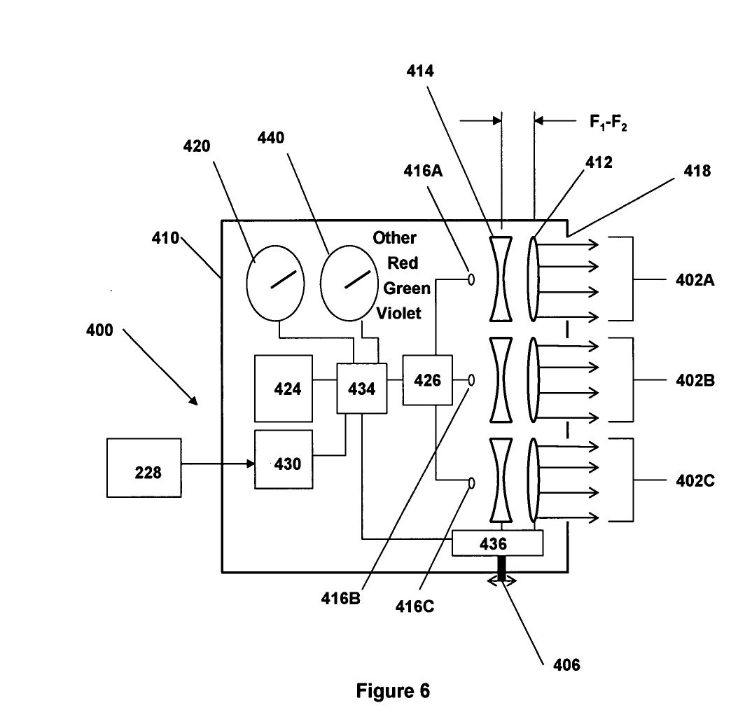

FIG. 6 is a block diagram of a second illumination device 400 consistent with an embodiment of the invention. The illumination device 400 may have two or more laser array emitters 416A, 416B, 416C capable of generating light at differing wavelengths. Aligned with each array emitter may be an afocal beam expander having a first lens 412 with a −F1 focal length and a second lens 414 having a F2 focal length may be disposed a spaced distance F2−F1 from the laser array emitter 416A, 416B, 416C to provide collimated light outputs 402A, 402B, 402C that extend through an aperture 418. The illumination device 400 may be housed in a housing 410 that can be hand held, weapon-mounted, or mounted on a remotely controllable actuator. A user adjustable adjustor knob 406 may be coupled to the housing 410 and allow an operator to change the distance between the lenses 412, 414 to adjust the divergence of the light output 402A, 402B, 402C from the device 400 from narrow to wide. Alternatively, an electrically controllable actuator 436 coupled to the controller 434 may change the distance between the lenses 412, 414 to adjust the divergence of the light output 402A, 402B, 402C. The device 400 may have an internal power supply 424, for example a dry cell battery, or may receive power from a remote source. A selector 420 may allow a user to adjust the output power through the controller 434 and a variable laser driver circuit 426. A selector 440 may allow a user to select the output color.

Using a range finder 228 and a look-up table 430, the controller 434 can adjust the output beams 402A, 402B, 402C to be retina safe at the object being illuminated by adjusting the output of the emitter 416A, 416B, 416C or by changing the divergence of the output beams 402A, 402B, 402C. Similar control of the output power as noted above with reference to FIG. 4 could be applied to any transmitted visible color (red, blue, green, etc., combination) such that the output beam would be retina safe.

Although several embodiments have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

What is claimed is:

1. An illumination device, comprising:
a housing;
a power supply;
a first array of laser emitters having a first principal wavelength disposed at least partially in the housing;
a second array of laser emitters having a second principal wavelength disposed at least partially in the housing; and
a selector that allows a user to selectively couple the power supply to the first and the second array of emitters.

2. The illumination device of claim 1, further comprising an afocal beam expander for controlling the divergence of an exiting light beam.

3. The illumination device of claim 2, wherein the device has a user adjustable actuator coupled to one of the first lens and the second lens that allows the user to adjust the divergence of the exiting light beam.

4. The illumination device of claim 1, wherein a variable laser driver circuit controls the output power of the first array of laser emitters to provide a retina safe output at an object based on the distance from the device to the object.

5. An illumination device, comprising:
a housing;
a power supply;
a laser emitter disposed at least partially in the housing; and
a variable laser driver circuit, the variable laser driver circuit configured to provide a retina safe output at an object based on a distance from the device to the object.

6. The illumination device of claim 5, wherein a variable laser driver circuit controls the output power of the laser emitter to provide a retina safe output at the object.

7. An illumination device, comprising:
a housing,
a power supply,
a laser emitter disposed at least partially in the housing and aligned with an afocal beam expander,
an electrically controllable actuator configured to provide a retina safe output at an object based on a distance from the device to the object by adjusting the distance between lenses of the afocal beam expander.

8. The illumination device of claim 7, wherein the adjusting of the distance between the lenses of the afocal beam expander adjusts the divergence of the light beam from the laser emitter.
